(19) United States
(12) Patent Application Publication
(10) Pub. No.: US 2015/0218785 A1
(43) Pub. Date: Aug. 6, 2015

(54) AUTOMATED ROOF RUNOFF MANAGEMENT SYSTEM

(71) Applicants: MICAH ETHAN SHAPIRO, Philadelphia, PA (US); ANKER BERG-SONNE, Stown, MA (US); KEVIN CHARLES DUTT, Newton Center, MA (US); JOHN RANDOLPH EGGLESTON, Brookline, MA (US)

(72) Inventors: MICAH ETHAN SHAPIRO, Philadelphia, PA (US); ANKER BERG-SONNE, Stown, MA (US); KEVIN CHARLES DUTT, Newton Center, MA (US); JOHN RANDOLPH EGGLESTON, Brookline, MA (US)

(73) Assignee: RAINBANK, INC., NEWTON CENTER, MA (US)

(21) Appl. No.: 14/576,749

(22) Filed: Dec. 19, 2014

Related U.S. Application Data
(60) Provisional application No. 61/918,726, filed on Dec. 20, 2013.

(51) Int. Cl. E03C 1/122; G01W 1/14; G06F 9/44

(52) U.S. Cl. CPC E03C 1/122; G06F 9/44; G01W 1/14

(57) ABSTRACT

The Automated Roof Runoff Management System mitigates the impact of storm water overwhelming existing infrastructure to handle it by automatically retaining storm water on roofs and releasing it at times where the system has adequate capacity to handle the retained water.

### TECHNICAL FIELD AND INDUSTRIAL APPLICABILITY OF THE INVENTION

This invention relates to the collection and release of water from a building roof, and more specifically relates to a novel valve and control system therefore to deliver such water from the roof in a controlled manner.

### BACKGROUND OF THE INVENTION

The growth of cities has increased reliance on undersized storm water conveyance systems. The high concentration of impervious area and undersized storm water systems in older cities, such as New York, Philadelphia, Washington D.C., causes several problems 1) pollution from sewage overflows and other contaminants 2) stream degradation and 3) flooding. In many cities the storm water system shares infrastructure with the sanitary sewer in what is called a combined sewer system. During storm events, runoff from impervious surfaces such as roofs and pavement causes the storm water system to overflow into the wastewater sewer system, and vice versa, which result in combined sewer overflows (CSO). That is, when the system is overloaded, the untreated combination of storm water and effluence overflows directly into the local waterways.

For the purposes of this invention, the term “storm water system” includes includes storm drains, underground pipes, retention ponds, tanks, ditches, channels, natural bodies of water, and any other system that receives storm water runoff.

Many urban municipalities have increased storm water management regulations to reduce problems related to stormwater runoff. A common regulation mandates that a developed real estate property must store the first one (1) inch of storm water for a minimum of seventy-two (72) hours after the rain gauge senses the end of the storm event. The regulation varies between municipalities but the popularity of stringent storm water regulations is on the rise. This increase in regulation translates into increased costs for developers and, in some municipalities, all property owners.

The most common methods of on-site roof-top storm water mitigation are green roofs, gray water harvesting, and blue roofs. Green roofs treat storm water by storing it in the growing media and releasing it back into the hydrologic cycle through evapotranspiration. Grey water harvesting systems utilize storm water for property and building systems that do not require potable water (i.e. irrigation, toilet flushing, car wash). Blue roofs are systems of weirs installed throughout the roof that slow the discharge of the storm water by extending the time it takes to get to the down spout or roof drain. It is not uncommon for these systems to be utilized in combination, or in sequence as well. All of these systems represent an increased cost for proposed development and substantial costs to existing buildings.

### BRIEF SUMMARY OF THE INVENTION

In accordance with the invention, a novel controllable valve is installed in the path of water accumulated on a roof or other structure, thus retaining the water on the roof to be discharged at a later time. The controllable valve communicates with a central computer. Based on weather forecasts, current precipitation, and other sensor data, the valve closes to retain water at key times to keep the underground storm water system from reaching overcapacity.

The valve is computer controlled, responding to commands from the computer, which determines the optimal performance of the system based on the outputs of a weather forecasts, rooftop sensors, as well as sensors within the storm water system. The computer uses the information from these devices to determine the optimal time to close the valve and retain water on the rooftop, as well as open the valve and release the collected water when the system can handle the additional volume.

The valve may be affixed directly to a scupper, roof drain, or down spout and realeases water based on algorithms that determine the best time to release the water into the main underground storm drain.

### BRIEF DESCRIPTION OF THE DRAWINGS

FIG. 1 is a partial cross-sectional drawing of a valve from the first embodiment in a closed position and secured to a building roof and its down spout.

FIG. 2 a view of a rooftop with an automated runoff management system from the second embodiment installed.

FIG. 3 is a cross-sectional drawing of a valve from the second embodiment in a closed position and installed on a roof top.

FIG. 4 is a block diagram of the control flow from the first embodiment.

FIG. 5 is a block diagram of the control flow from the second embodiment.

FIG. 6 is a block diagram of the control flow for determining the optimal time to close the valves in the second embodiment.

FIG. 7 is a block diagram of the control flow for determining the optimal time to open the valves in the second embodiment.

FIG. 8 is a partial cross-sectional diagram of the base station in the second embodiment.

FIG. 9 is a diagram of a municipal rooftop runoff management system as in the third embodiment.

### DETAILED DESCRIPTION OF THE INVENTION

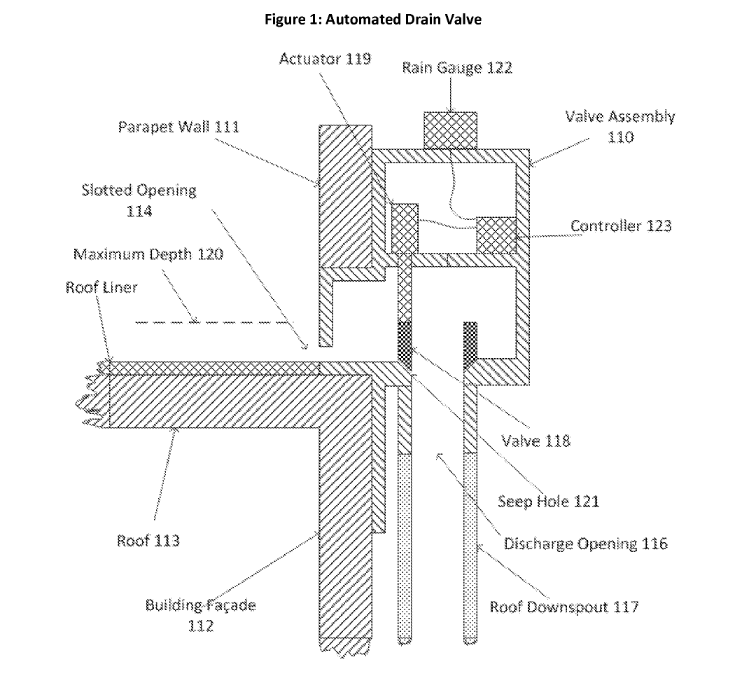

### First Embodiment, FIGS. 1-2, 4

The first embodiment describes an automated roof drain valve that delays runoff by a set time delay after precipitation has ended, or can be networked together with a computer to retain and release water based on the calculated optimal times to retain water on the building.

Referring to FIG. 1 there is shown the novel valve assembly 110 of the invention which is suitably secured to a building parapet wall 111 and the building facade 112. Valve assembly 110 extends through a sealed opening in roof 113. The valve assembly has a slotted opening 114 to receive rain water and the like accumulated on the roof 113, and a discharge opening 116 connected to the roof downspout 117 (or an in-deck drain). The slotted opening 115 has a restricted height to act as a debris guard. The valve 118 is shown as a cylindrical valve body raised and lowered by an actuator 119 between its raised (open) position and lowered (closed) position. Actuator 119 is electrically controlled by a controller 123. The valve height is set so the water level on the roof 113 cannot exceed a maximum depth 120, above which it will spill over the top of the closed valve 118. Valve 118 is also equipped with a seep hole 121 to ensure that the roof 113 will drain even if actuator 119 were to become stuck. Any other type of valve structure can be employed in accordance with the invention. The valve is opened when it is desired to discharge fluid from roof 113 to downspout 117 (or other discharge channel).

Valve assembly 110 may also contain a rain gauge 122 that is connected to controller 123. Controller 123, rain gauge 122 and actuator 119 are powered by a suitable supply such as a battery, potentially charged by a solar collector, or a mains powered transformer. Controller 123 may also communicate with other valves, an on-site computer, or a remotely located computer, which notifies it when to open and close.

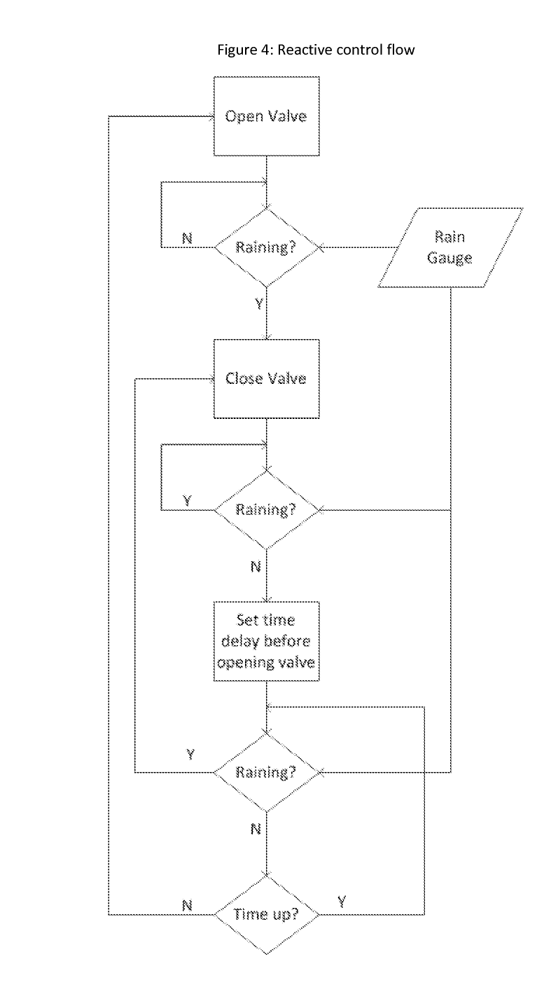

### First Embodiment Operation, FIG. 4

FIG. 4 shows the control flow implemented in controller 123.

By default valve 118 is positioned in its raised, open, position. Upon detection of precipitation by rain gauge 122 or communication from remote computer, controller 123 signals actuator 119 to close valve 118.

When rain detector 122 senses the end of precipitation or is notified by the remote computer, controller 123 signals actuator 119 to open valve 118.

If precipitation is detected during the delay, controller 123 signals actuator 119 to close the valve 118.

If valve 118 is closed and the water level on roof 113 exceeds the height of valve 118 it will drain through the hollow center of valve 118, thus ensuring that the water retention capacity of roof 113 is limited.

Also, if valve 118 is closed and some failure causes actuator 119 to become stuck, retained water will drain slowly through seep hole 121 ensuring that the retained water will not become stagnant or polluted with algae or mosquito larvae.

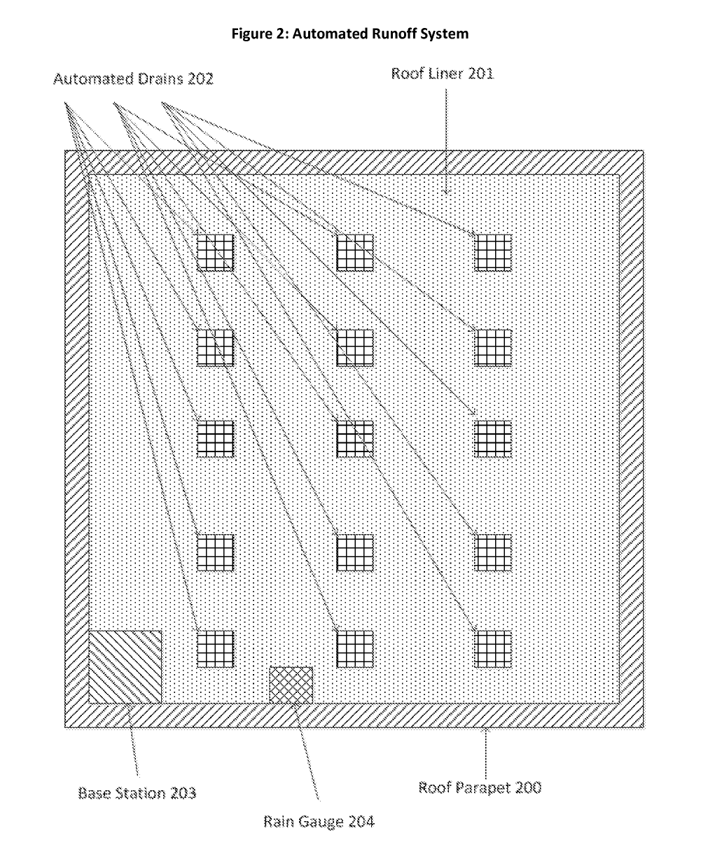

### Second Embodiment, FIGS. 2-3, 5-8

The second embodiment describes an automated rooftop runoff management system that controls runoff from a rooftop optimally according to one or more criteria dictated by an authority such as federal or state law, federal, state or municipal regulations, or owner set criteria, using currently retained depth of water, current precipitation, forecasted precipitation, and capacity sensors in the receiving storm water system.

FIG. 2 shows a building roof with an automated runoff management system installed. Roof parapet 200 and roof liner 201 retain precipitation and drainage from the roof is is controlled by automated drains 202. Base station 203 detects precipitation with rain gauge 204 and is also connected to a suitable power supply and a network connection to a weather forecast data feed.

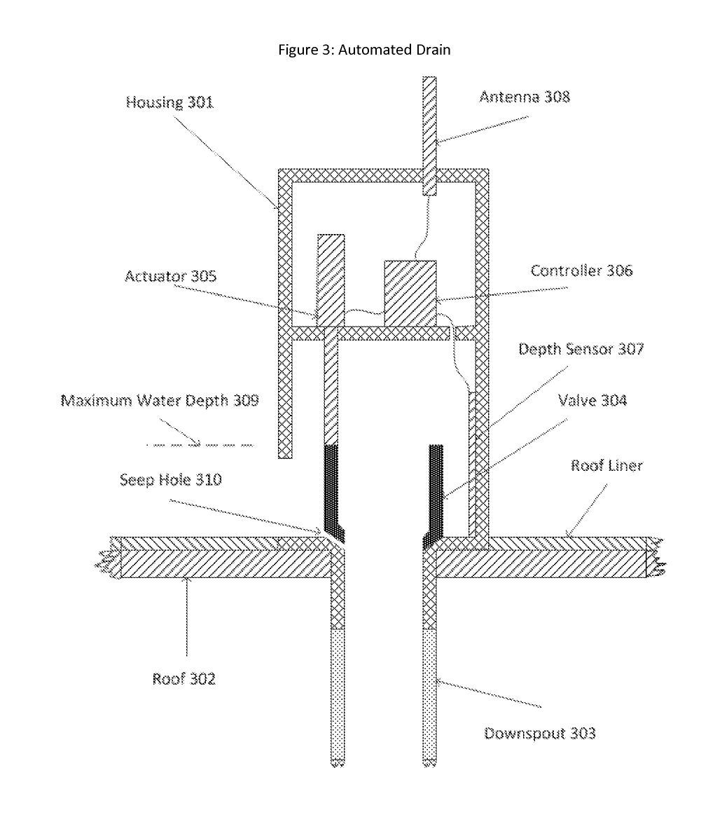

FIG. 3 is a detail view of automated drain 202. Housing 301 is attached and sealed to roof 302 and drain 303. Cylindrical valve 304 is raised and lowered by actuator 305 between its lowered, closed, position and raised, open, position. Actuator 305 is electrically controlled by controller 306, which is also electrically connected to depth sensor 307 and antenna 308. Actuator 305, controller 306, and depth sensor 307 are all powered by a suitable supply (not shown) such as a mains powered transformer or a battery charged by solar cells.

Controller 306 communicates wirelessly with base station 203 through antenna 308, or some other suitable network.

Valve 305 has a limited height to ensure that the amount of retained water on the roof cannot exceed maximum water depth 309, in which case it will drain over the top of closed valve 305.

Valve 305 is also designed with seep hole 310 to ensure that if actuator 305 were to become stuck with valve 304 in the closed position, retained water will drain slowly and not become stagnant and potentially polluted with algae and mosquito larvae.

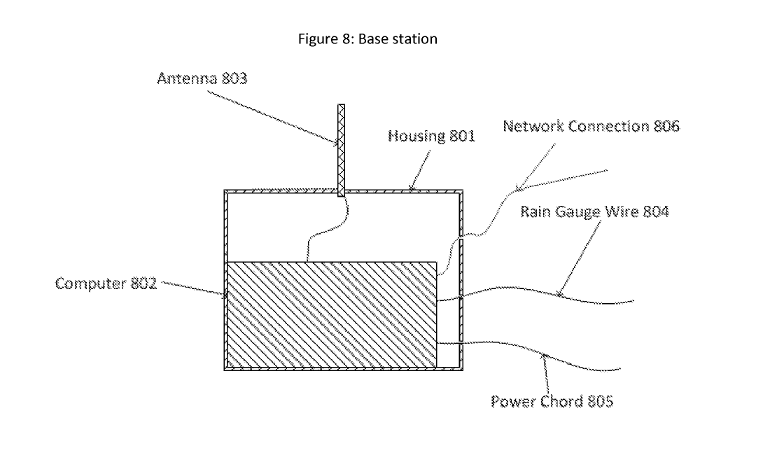

FIG. 8 shows base station 203. Housing 801 protects the contents against handling and weather. Computer 802 is powered with some suitable power through power chord 805, and receives data from rain gauge 204 through rain gauge wire 804.

Computer 802 communicates wirelessly with automated drains 202 through antenna 803 or some other suitable network connection, and communicates with a precipitation forecast data source and other base station 203s through network connection 806 or some other suitable network connection such as wireless broadband.

### Second Embodiment Operation, FIGS. 2-3, 5-8

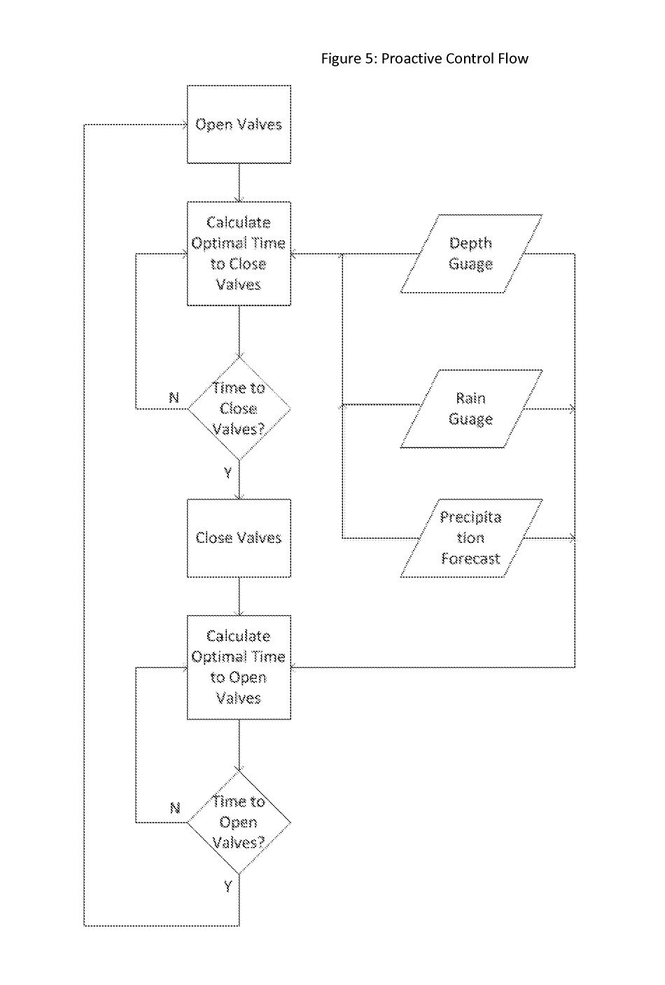

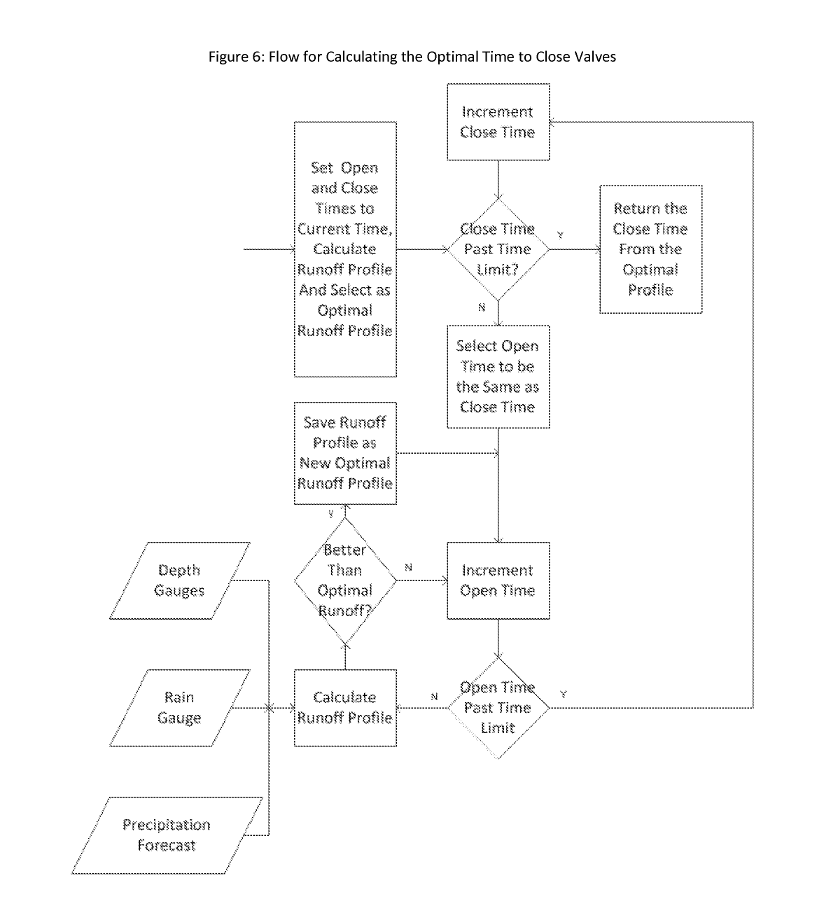

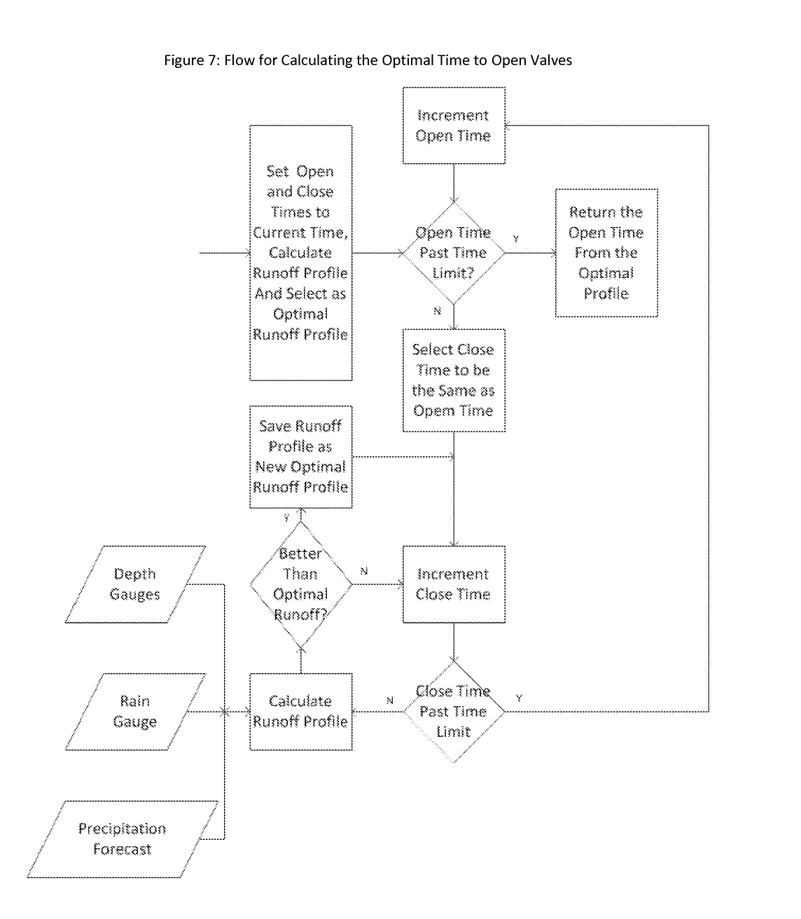

FIG. 5 shows the control flow implemented on computer 802. The normal position of valves 304 is open. Based on readings from depth sensor 307, rain gauge 204 and precipitation forecasts received through network connection 806 the optimal time to close valves 304 is calculated according the control flow outlined in FIG. 7 and the optimal time to close valves is calculated according to the flow outlined in FIG. 6. When valves 302 are open, the optimal closing time is continually calculated until the current time and the optimal closing time are identical, at which time valves 302 are closed. When valves 302 are closed, the optimal opening time is continually calculated until the current time and the optimal opening time are identical, at which time valves 302 are opened.

FIG. 6 outlines the flow for calculating the optimal time to close valves 304. The times for opening and closing valves are incrementally increased and for each setting the runoff profile is calculated and then evaluated against criteria set by law, regulatory agencies, municipalities or owners. The valve 304 closing time for the optimal runoff profile as evaluated against these criteria is selected as the optimal closing time.

FIG. 7 outlines the flow for calculating the optimal time to open valves 304. The times for opening and closing valves are incrementally increased and for each setting the runoff profile is calculated and then evaluated against criteria set by law, regulatory agencies, municipalities or owners. The valve 304 opening time for the optimal runoff profile as evaluated against these criteria is selected as the optimal opening time.

Top open or close the valves the base station 203 sends a network signal to controllers 306 in all automated drains 202. The controller 306 then sends an electrical signal to actuator 305 to open or close the valve.

Readings from depth sensor 307 in each automated drain 203 are sent by network signal to base station 203 for storage and use in calculating runoff profiles.

Base station 203 retrieves precipitation forecasts from weather services such as NOAA or Weather Underground over network connection 806 on a regular basis, such as every 15 minutes.

Base station 203 retrieves current precipitation from rain gauge 204 through rain gauge wire 804.

### Third Embodiment, FIG. 2-3, 9

The third embodiment describes a rooftop runoff management system consisting of a plurality of individual rooftop management systems as in the second embodiment, collectively controlling runoff from the plurality of rooftops optimally according to one or more criteria dictated by an authority such as federal or state law, federal, state or municipal regulations, or owner set criteria, using currently retained depth of water, current precipitation and forecasted precipitation.

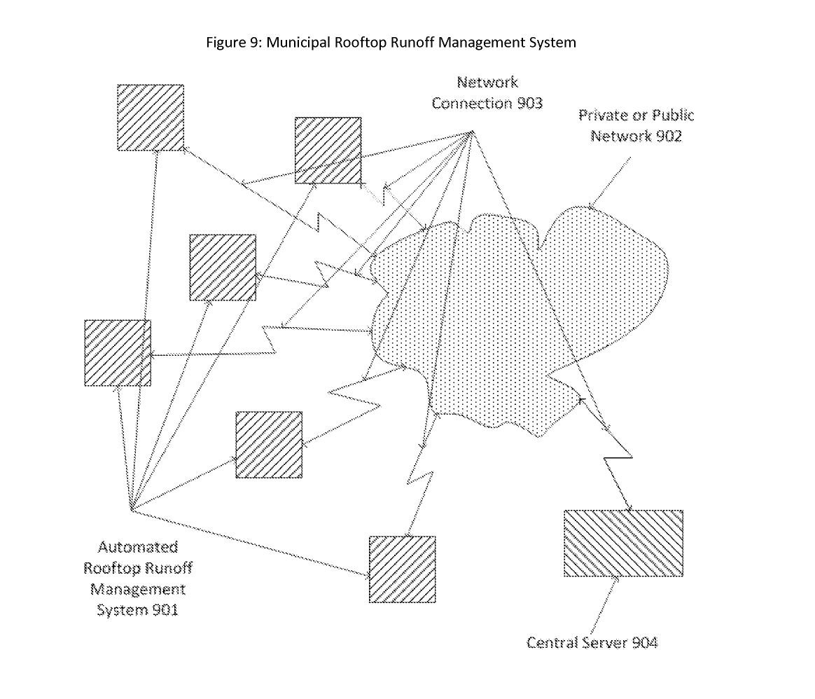

FIG. 9 is a diagram of a municipal rooftop runoff management system in which a plurality of rooftop runoff management systems 901 as in the second embodiment are connected to a central server 904 over a private or public network 902 through network connections 903.

### Third Embodiment Operation

In this embodiment different rooftop runoff management systems 901 may open or close valves 304 at different times than other rooftop management systems 901, in order to optimize runoff across the entire municipality.

If a rooftop runoff management system 901 is unable to communicate with central server 904 it will operate as described in embodiment 2.

If a rooftop management system 901 is capable of communicating with central server 904 the selection of times when to open valves 304 in the rooftop runoff management system 901 is determined by the central server based on valve 304 status, depth sensor 307 status and rain gauge 204 status from the plurality of rooftop management systems 901. For example, regulation may only allow a subset of the plurality of rooftop management system 901 s to discharge concurrently.

Although the present invention has been described in relation to particular embodiments thereof, many other variations and modifications and other uses will become apparent to those skilled in the art. It is preferred, therefore, that the present invention be limited not by the specific disclosure herein.

What is claimed is:

1. An automated storm water management system comprising:
a) One or multiple rooftops
b) On each rooftop (a), one or multiple drains each with an actuator-controlled valve and an electronic controller for opening and closing the valve by energizing the actuator
c) One or multiple computers connected to the controllers (a) through wired or wireless network connections, with the computers connected with each other through wired or wireless network connections
d) Zero or more depth sensors attached to the valve assemblies (b)
e) Zero or more rain gauges connected to one or more of the computers (c) either directly or through wired or wireless network connections
f) Computer programs running on the computers (c) that communicate with each other, the controllers (b) and the rain gauges (e) to automate opening and closing of the valves (a)
g) Programs running on computers (c) that optimize the times of opening and closing valves to collect and release rooftop storm water to achieve one or more specific goals such as:
i) Retain rooftop water during heavy rainfall to prevent overflow in the receiving storm water system
ii) Retain rooftop water during heavy rainfall to prevent overflow into natural bodies of water
iii) Retain water for reuse on-site or off-site
iv) Divert and/or collect water based on water quality for treatment or retention
v) Other requirements from one or more of
(1) Building owners
(2) Municipalities
(3) Waste water authorities
(4) State agencies
(5) Federal agencies

2. The automated storm water management system of claim 1 wherein the valve has an overflow bypass that limits the depth of storm water retained by the valve

3. The automated storm water management system of claim 1 wherein the valve has a built-in seep bypass

4. The automated storm water management system of claim 1 wherein the computers collect weather forecasts through a wired or wireless network connection

5. The automated storm water management system of claim 1 wherein valves are closed and opened by computer programs in response to data received from the rain gauges, rooftop sensors, and capacity sensors in the outflow storm water system

6. The automated storm water management system of claim 4 wherein the valves are closed and opened by computer programs in response to data received from the rain gauges and other sensors, and in anticipation of future rainfall predicted in the weather forecasts
